(19) United States
(12) Patent Application Publication
(10) Pub. No.: US 2020/0185851 A1
(43) Pub. Date: Jun. 11, 2020

(54) TERMINAL FITTING

(71) Applicants: Sumitomo Wiring Systems, Ltd., Yokkaichi-shi, Mie (JP); SUZUKI CO., LTD., Suzuka-shi, Nagano (JP)

(72) Inventors: Nobuyoshi Tanaka, Yokkaichi-shi, Mie (JP); Yuichi Nanko, Yokkaichi-shi, Mie (JP); Takafumi Higashio, Suzuka-shi, Nagano (JP); Akira Takayama, Suzuka-shi, Nagano (JP)

(21) Appl. No.: 16/642,077

(22) PCT Filed: Aug. 24, 2018
(86) PCT No.: PCT/JP2018/031276

§ 371 Date: Feb. 26, 2020

(30) Foreign Application Priority Data
Aug. 29, 2017 (JP) 2017-164016

(51) Int. Cl. H01R 13/41; H01R 13/04

(52) U.S. Cl. CPC H01R 13/41; H01R 13/04

(57) ABSTRACT

A terminal fitting (10) is a press-formed product of a metal plate and includes a tab portion (11). The tab portion (11) includes a contact portion (21) on at least one of two surfaces facing opposite sides in a plate thickness direction that comes into contact with a mating terminal fitting, and includes a press recess (22) on at least one of two surfaces facing opposite sides in a plate width direction that increases a plate thickness.

### BACKGROUND

### Field of the Invention

The present invention relates to a terminal fitting.

### Related Art

Japanese Unexamined Patent Application Publication No. 2014-175196 discloses a male terminal formed by pressing a plate-shaped base material made of a conductive metal. The male terminal is provided with a tongue-shaped tab on the distal end side. The tab has two flat surfaces facing opposite sides in a plate thickness direction each having a contact portion to be in electrical contact with a female terminal that is a counterpart of the connection.

In the case of this type of male terminal, a tab needs to have a predetermined plate thickness, and a metal plate serving as a base material also needs to have a plate thickness corresponding to the tab. On the other hand, since the material cost of the metal plate constitutes most of the manufacturing cost, it is desired to thin the metal plate in order to reduce the material cost.

The present invention has been completed based on the above situation and aims to provide a terminal fitting capable of reducing material costs.

### SUMMARY

A terminal fitting of the present invention is a press-formed product of a metal plate and includes a tab portion. The tab portion includes a contact portion on at least one of two surfaces thereof facing opposite sides in a plate thickness direction. The contact portion comes into contact with a mating terminal fitting. The tab portion includes a press recess on at least one of two surfaces thereof facing opposite sides in a plate width direction. The press recess increases a plate thickness.

Since the plate thickness of the tab portion is increased by the press recess, a predetermined plate thickness of the tab portion can be ensured even if the metal plate serving as a base material is made thinner than the conventional one. Thus, material costs can be reduced by making the metal plate thinner than the conventional one.

The press recess may include an inclined surface inclined in a direction approaching at least one of the two surfaces facing opposite sides in the plate thickness direction from an inner side toward an opening side of the press recess. According to this configuration, a metal plate can be plastically flowed along the inclined surface of the press recess, and a surface having a contact portion can be formed smoothly.

The press recess may be provided on each of the two surfaces facing opposite sides in the plate width direction. According to this configuration, the surface having the contact portion can be accurately formed from both sides in the plate width direction.

A press-fitting portion to be press-fitted into a press-fitting hole of a connector housing may be provided continuously to a proximal end of the tab portion. The press-fitting portion may preferably include a second press recess on one of two surfaces thereof facing opposite sides in the plate thickness direction and include a bulging portion on the other surface. The bulging portion corresponds to the second press recess. According to this configuration, the thickness of the metal plate can be reduced including the press-fitting portion. Further, a bulging end surface of the bulging portion abuts against a hole surface of the press-fitting hole, so that the press-fitting portion can be press-fitted into the press-fitting hole without play in the plate thickness direction.

The surface having the contact portion and the bulging end surface of the bulging portion may be continuous without step. According to this configuration, it is possible to prevent a connecting portion between the surface having the contact portion and the bulging end surface of the bulging portion from being caught by the connector housing in the process of press-fitting the press-fitting portion into the press-fitting hole. As a result, press-fitting work can be performed smoothly.

The press recess may displace only one of the two surfaces of the tab portion facing opposite sides in the plate thickness direction in a direction to increase the plate thickness. According to this configuration, flatness of the other surface that is not displaced can be reliably maintained, so that connection reliability of the contact portion can be improved by providing the contact portion on the other surface.

### BRIEF DESCRIPTION OF DRAWINGS

FIG. 1 is a perspective view of a terminal fitting according to Embodiment 1 of the present invention.

FIG. 2 is a side view of a main part of the terminal fitting.

FIG. 3 is a bottom view of the main part of the terminal fitting.

FIG. 4 is a plan view of the main part of the terminal fitting.

FIG. 5 is a cross-sectional view taken along line A-A in FIG. 4.

FIG. 6 is a cross-sectional view taken along line B-B in FIG. 4, showing a state where a press-fitting portion is press-fitted into a press-fitting hole of a connector housing.

FIG. 7 is a cross-sectional view showing a step of forming a press recess on both side surfaces of a tab portion by pressing.

### DETAILED DESCRIPTION

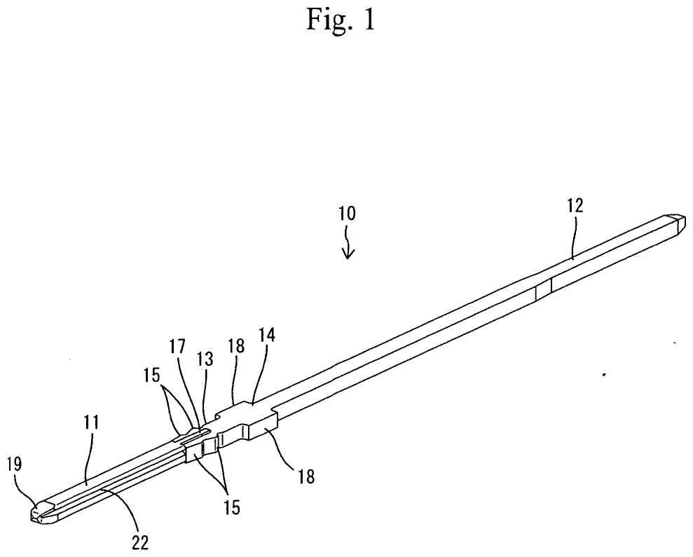

An embodiment of the present invention will be described with reference to FIGS. 1 to 7. A terminal fitting 10 according to Embodiment 1 is formed by punching a conductive metal plate made of copper, a copper alloy, or the like by pressing. Specifically, a chain terminal is first formed by punching the metal plate. The chain terminal has a carrier from which a plurality of semi-finished terminal fittings protrude in parallel. After press working is applied to the chain terminal, the terminal fitting 10 is cut from the carrier and formed.

As shown in FIG. 1, the terminal fitting 10 is in the form of a solid rectangular bar elongated in the front-rear direction as a whole. The terminal fitting 10 includes a tab portion 11 at a front portion and a board connecting portion 12 at a rear portion. The board connecting portion 12 is formed longer than the tab portion 11, is inserted into a connection hole of a printed circuit board, and is electrically connected to a conductive portion of the printed circuit board. The board connecting portion 12 may be bent as necessary.

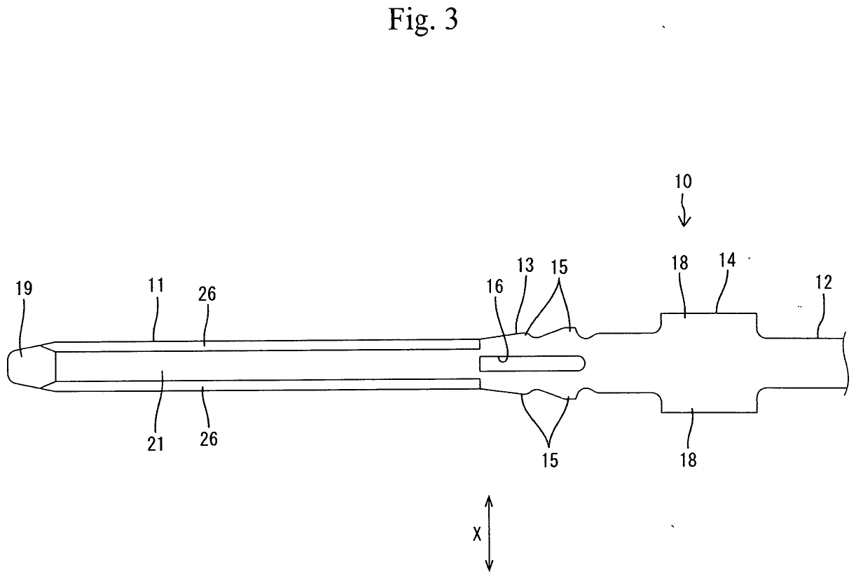

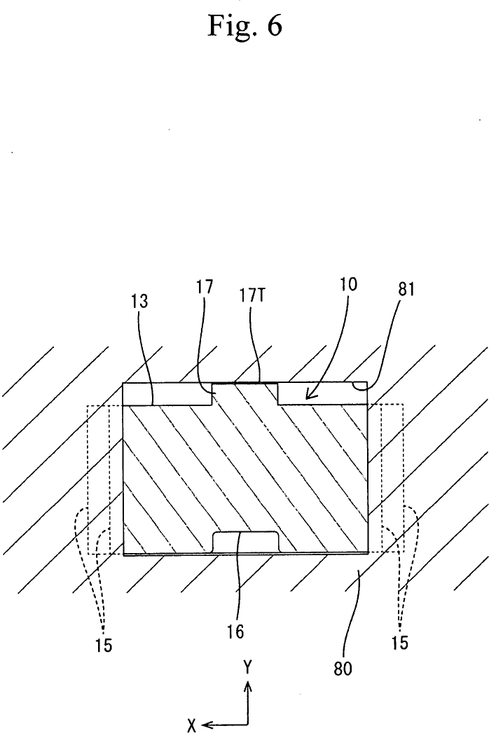

The terminal fitting 10 further includes a press-fitting portion 13 and a stopper portion 14 between the tab portion 11 and the board connecting portion 12. As shown in FIG. 6, the press-fitting portion 13 is press-fitted into a press-fitting hole 81 provided in a connector housing 80 mounted on the printed circuit board. As shown in FIG. 3, a plurality of protrusions 15 is provided on both side surfaces of the press-fitting portion 13 (both surfaces facing opposite sides in the plate width direction (X direction in the drawing)). The protrusions 15 are arranged side by side in a sawtooth shape. When the press-fitting portion 13 is press-fitted into the press-fitting hole 81, the protrusions 15 are bitten into both side surfaces of the press-fitting hole 81 to be locked, so that the terminal fitting 10 is held in the connector housing 80 so as not to be detached.

As shown in FIG. 6, both upper and lower surfaces of the press-fitting portion 13 (both surfaces facing opposite sides in the plate thickness direction (Y direction in the drawing)) are flat along a right-left direction (the same direction as the X direction in the drawing) and are arranged parallel to each other. The lower surface of the press-fitting portion 13 is provided with a second press recess 16 at its central portion in the right-left direction. The second press recess 16 has a rectangularly recessed cross-section, and has a slit groove shape extending in the front-rear direction over substantially the entire length of the press-fitting portion 13. The second press recess 16 is compressed and formed by being pressed by a convex pressing die corresponding to the second press recess 16.

The upper surface of the press-fitting portion 13 is provided with a bulging portion 17 at its central portion in the right-left direction that is bulged and deformed in accordance with the formation of the second press recess 16. The bulging portion 17 has a rectangularly convex cross-section corresponding to the second press recess 16, and has a rib shape extending in the front-rear direction over substantially the entire length of the press-fitting portion 13. A bulging end surface 17T of the bulging portion 17 is disposed flat along the right-left direction. A separation distance between the bulging end surface 17T of the bulging portion 17 and the lower surface of the press-fitting portion 13 is larger than the vertical dimension of the side surfaces of the press-fitting portion 13 by the amount of bulging of the bulging portion 17, and is the same as or slightly smaller than an opening dimension of the press-fitting hole 81 in the vertical direction. Accordingly, when the press-fitting portion 13 is press-fitted into the press-fitting hole 81, the lower surface of the press-fitting portion 13 is disposed so as to be able to abut against the lower surface of the press-fitting hole 81, and the bulging end surface 17T of the bulging portion 17 is disposed so as to be able to abut against the upper surface of the press-fitting hole 81, as shown in FIG. 6. Thus, the press-fitting portion 13 is disposed in the press-fitting hole 81 of the connector housing 80 substantially without a gap in the vertical direction.

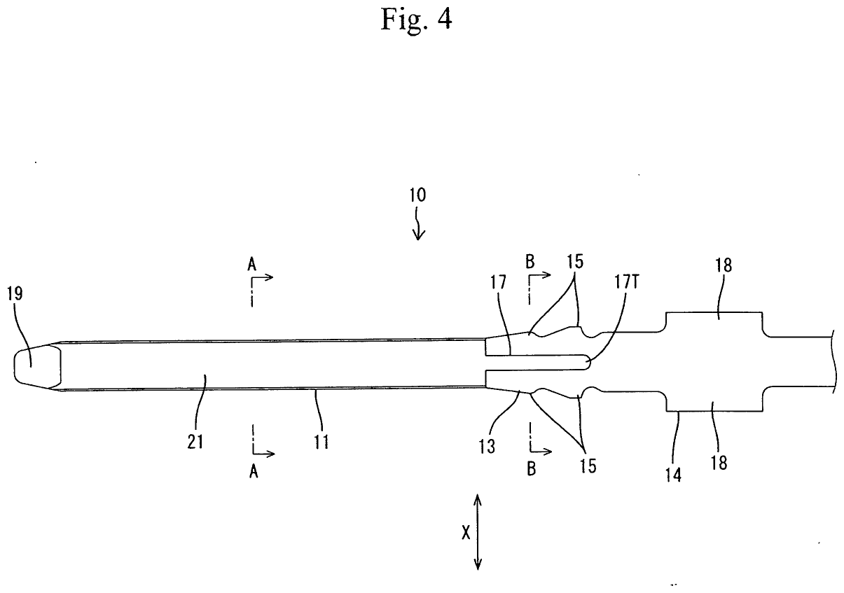

As shown in FIGS. 1 and 4, the stopper portion 14 is located behind the press-fitting portion 13, and a pair of wing portions 18 projects from the right and left sides. The press-fitting portion 13 is inserted into the press-fitting hole 81 from behind, and both wing portions 18 are brought into contact with and stopped at a rear surface of the connector housing 80, whereby a mounting position of the terminal fitting 10 with respect to the connector housing 80 is defined. In a state where the terminal fitting 10 is thus mounted on the connector housing 80, the tab portion 11 is disposed so as to protrude forward (usually in a hood) from a main body of the connector housing 80.

A distal end of the tab portion 11 has a tapered surface 19 diameter of which is reduced in a tapered manner. A press-fitting operation of the terminal fitting 10 into the press-fitting hole 81 is guided by guiding of the tapered surface 19.

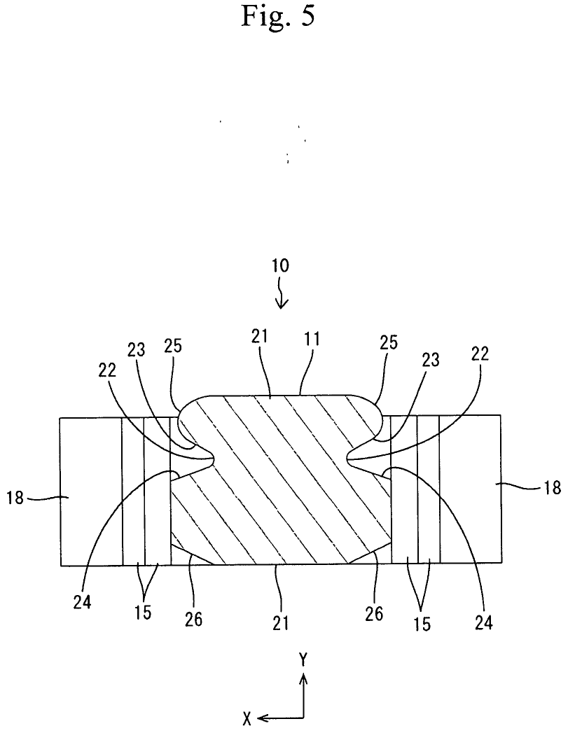

As shown in FIG. 5, upper and lower surfaces of the tab portion 11 (both surfaces facing the opposite sides in the plate thickness direction (Y direction in the drawing)) are flat along the right-left direction (the same direction as the X direction in the drawing) and arranged parallel to each other. The upper and lower surfaces of the tab portion 11 each have a contact portion 21 with which a contact portion of a mating terminal fitting elastically comes into contact.

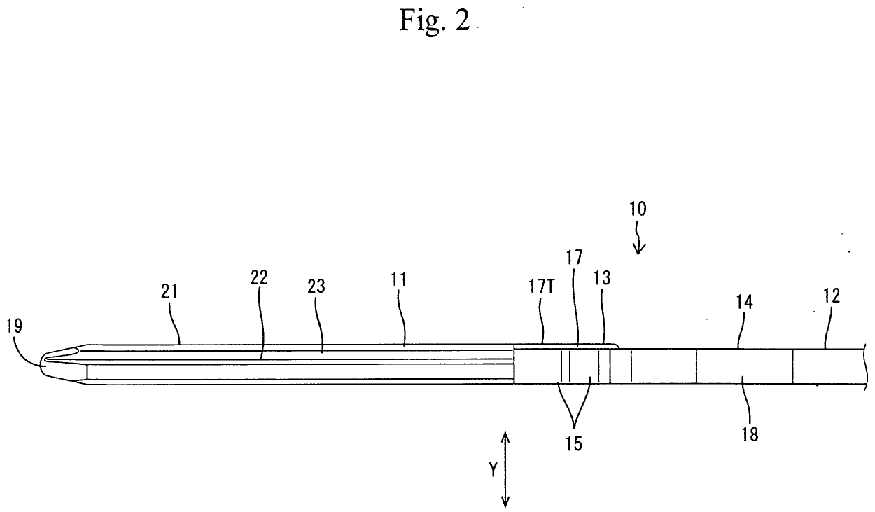

Both side surfaces of the tab portion 11 (surfaces facing the opposite sides in the plate width direction (X direction in the drawing)) are arranged parallel to each other so as to stand upright (the same direction as the Y direction in the drawing). Upper portions of both side surfaces of the tab portion 11 (portions above vertically central portions) are provided with respective press recesses 22. Each press recess 22 has a substantially V-shaped cross section, and has an inclined surface 23 and a small inclined surface 24 in a tapered shape expanding toward the side surface of the tab portion 11. The inclined surface 23 located on the upper side has a larger inclination angle with respect to a horizontal axis in the right-left direction than the small inclined surface 24. As shown in FIG. 2, the press recess 22 has a notch groove shape extending in the front-rear direction over the substantially entire length of the tab portion 11, including a distal end having the tapered surface 19.

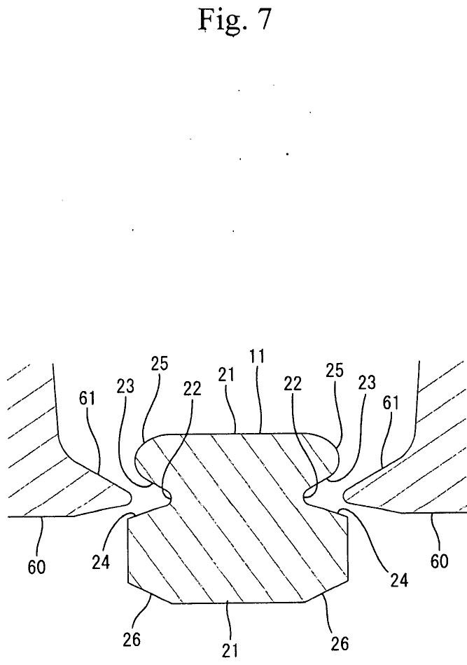

As shown in FIG. 7, the press recess 22 is compressed and formed by being pressed by a convex pressing die 60 corresponding the press recess 22. When the pressing die 60 having a inclined surface portion 61 corresponding to the inclined surface 23 of the press recess 22 is driven into the side surface of the tab portion 11, the material on the side surface side is caused to plastically flow upward, so that a height position of the upper surface is located above a height position at the time of die-punching. That is, the tab portion 11 is raised by the inclined surface 23 of the press recess 22, and the plate thickness thereof is increased.

Right and left corner portions 25 on the upper side of the tab portion 11 are slightly retracted toward an inner side (a center side in the right-left direction) by upward plastic flow in accordance with the formation of the press recess 22, and have a curved shape. On the other hand, right and left corner portions 26 on the lower side of the tab portion 11 substantially do not become deformed portions with plastic flow, and are taper-chamfered.

As shown in FIGS. 1 and 2, the upper surface of the tab portion 11 continues to the bulging end surface 17T of the bulging portion 17 at substantially the same height position, and a connecting portion between the upper surface of the tab portion 11 and the bulging end surface 17T of the bulging portion 17 is substantially continuous without step. Further, the upper surface of the tab portion 11 is arranged one step higher than the upper surface of the press-fitting portion 13 excluding the bulging portion 17, an upper surface of the stopper portion 14, and an upper surface of the board connecting portion 12.

When the connector housing 80 is fitted to a mating connector housing, the contact portion of the mating terminal fitting mounted on the mating connector housing elastically comes into contact with the contact portions 21 on the upper and lower surfaces of the tab portion 11. In this case, even if the metal plate serving as a base material is made thinner, the plate thickness of the tab portion 11 is increased by the press recess 22. Therefore, a distance between the contact portions 21 on the upper and lower surfaces of the tab portion 11 can be ensured at a predetermined value, so that preferable connection between the terminal fitting 10 and the mating terminal fitting can be achieved.

As described above, the plate thickness of the tab portion 11 is increased by forming the press recess 22 on the side surface of the tab portion 11. Therefore, even if the metal plate serving as a base material is made thinner than the conventional one, the plate thickness of the tab portion 11 can be ensured. Thus, the metal plate can be made thinner than the conventional one, with the result that material costs can be reduced.

The second press recess 16 is provided on the lower surface of the press-fitting portion 13, and the bulging portion 17 corresponding to the second press recess 16 is provided on the upper surface of the press-fitting portion 13. Therefore, the bulging end surface 17T of the bulging portion 17 abuts against the upper surface of the press-fitting hole 81 of the connector housing 80, so that y the press-fitting portion 13 can be press-fitted into the press-fitting hole 81 without play in the vertical direction. Thus, even if the terminal fitting 10 is manufactured using a metal plate thinner than the conventional one, it is not necessary to change the design of the connector housing 80 from the conventional one. In addition, it is also not necessary to change the design of the mating terminal fitting and the mating connector housing to be connected from the conventional ones.

Moreover, since the upper surface of the tab portion 11 and the bulging end surface 17T of the bulging portion 17 are continuous without step, it is possible to prevent the connecting portion between the upper surface of the tab portion 11 and the bulging end surface 17T of the bulging portion 17 from being caught by the connector housing 80 in the process of press-fitting the press-fitting portion 13 into the press-fitting hole 81 of the connector housing 80. As a result, press-fitting work can be performed smoothly.

Since the press recess 22 has the inclined surface 23 inclined in the direction approaching the upper surface from the inner side toward the opening side of the press recess 22, plastic flow can be caused along the inclined surface 23 of the press recess 22, and the upper surface of the tab portion 11 can be formed smoothly.

Further, since the press recesses 22 are provided on both side surfaces of the tab portion 11, flatness of the upper and lower surfaces of the tab portion 11 can be ensured, and connection reliability of the contact portions 21 can be ensured.

Still further, since the press recess 22 displaces only the upper surface side of the tab portion 11 in the direction to increase the plate thickness, flatness of the lower surface of the tab portion 11 that is not displaced can be reliably maintained, so that connection reliability of the contact portion 21 can be further improved.

### Other Embodiments

Other embodiments will be briefly described below.

A terminal fitting may be connected to an end of an electric wire. In this case, the terminal fitting may preferably have a barrel portion to be connected to the end of the electric wire instead of the board connecting portion.

The contact portion may be provided on only one of the upper and lower surfaces of the tab portion.

The press recess need not have a small inclined surface, but for example, a lower surface corresponding to the small inclined surface may be disposed horizontally in the right-left direction.

The press recess may be provided on only one of both side surfaces of a tab.

Both upper and lower surfaces of the tab portion may be displaced in a plate thickness increasing direction by the press recess. In this case, the press recess may preferably be provided at a vertically central portion of each side surface of the tab portion, and inclined surfaces are provided on the upper and lower sides so as to be inclined at substantially the same inclination angle with respect to the horizontal axis.

### REFERENCE SIGNS LIST

10 terminal fitting
11 tab portion
13 press-fitting portion
16 second press recess
17 bulging portion
21 contact portion
22 press recess
23 inclined surface

1. A terminal fitting being a press-formed product of a metal plate and comprising a tab portion,
the tab portion including a contact portion on at least one of two surfaces thereof facing opposite sides in a plate thickness direction, the contact portion being configured to come into contact with a mating terminal fitting,
the tab portion including a press recess on at least one of two surfaces thereof facing opposite sides in a plate width direction, the press recess being configured to increase a plate thickness.

2. The terminal fitting according to claim 1, wherein the press recess includes an inclined surface inclined in a direction approaching at least one of the two surfaces facing opposite sides in the plate thickness direction from an inner side toward an opening side of the press recess.

3. The terminal fitting according to claim 2, wherein the press recess is provided on each of the two surfaces facing opposite sides in the plate width direction.

4. The terminal fitting according to claim 3, wherein
a press-fitting portion to be press-fitted into a press-fitting hole of a connector housing is provided continuously to a proximal end of the tab portion, and
the press-fitting portion includes a second press recess on one of two surfaces thereof facing opposite sides in the plate thickness direction and includes a bulging portion on the other surface, the bulging portion corresponding to the second press recess.

5. The terminal fitting according to claim 4, wherein the surface having the contact portion and a bulging end surface of the bulging portion are continuous without step.

6. The terminal fitting according to claim 5, wherein the press recess displaces only one of the two surfaces of the tab portion facing opposite sides in the plate thickness direction in a direction to increase the plate thickness.

7. The terminal fitting according to claim 1, wherein the press recess is provided on each of the two surfaces facing opposite sides in the plate width direction.

8. The terminal fitting according to claim 1, wherein
a press-fitting portion to be press-fitted into a press-fitting hole of a connector housing is provided continuously to a proximal end of the tab portion, and
the press-fitting portion includes a second press recess on one of two surfaces thereof facing opposite sides in the plate thickness direction and includes a bulging portion on the other surface, the bulging portion corresponding to the second press recess.

9. The terminal fitting according to claim 8, wherein the surface having the contact portion and a bulging end surface of the bulging portion are continuous without step.

10. The terminal fitting according to claim 1, wherein the press recess displaces only one of the two surfaces of the tab portion facing opposite sides in the plate thickness direction in a direction to increase the plate thickness.
